(19) United States
(12) Patent Application Publication
(10) Pub. No.: US 2001/0045691 A1
(43) Pub. Date: Nov. 29, 2001

(54) Method and apparatus for replacing a tap hole liner in a basic oxygen furnace/QBOP/AOD and all other types of converter vessels

(75) Inventors: Louis A. Grant JR., Murrysville, PA (US); Albert J. Kristoff, Glenshaw, PA (US)

Correspondence Address: William H. Logsdon, Esq., Webb Ziesenheim Logsdon Orkin & Hanson, P.C., 700 Koppers Building, 436 Seventh Avenue, Pittsburgh, PA, 15219, US

(73) Assignee: Louis A. Grant, Inc.

(21) Appl. No.: 09/822,891

(22) Filed: Mar. 30, 2001

Related U.S. Application Data
(60) Provisional application No. 60/193,828, filed on Mar. 31, 2000.

(51) Int. Cl. B23B 39/14; B23B 47/18

(52) U.S. Cl. 266/135; 408/75

(57) ABSTRACT

An apparatus and method for replacing the tap hole liner of a Basic Oxygen Furnace (BOF/QBOP/AOD and all other types of converter vessels) includes a multi-purpose movable utility vehicle, a water-cooled self-centering drill removably attached to the multi-purpose utility vehicle, and a tap hole liner installation guide removably attached to the multi-purpose utility vehicle in place of the water-cooled self-centering drill attachment.

### BACKGROUND OF THE INVENTION

1. Field of the Invention

The present invention relates to a basic oxygen furnace (BOF) and, more particularly, to a method and apparatus for replacing a BOF/QBOP/AOD and all other types of converter vessels tap hole liner.

2. Brief Description of the Prior Art

In conventional basic oxygen furnaces (BOFs), molten metal from the furnace is removed through a tap hole formed in a well block of the furnace. The well block is made of refractory material and has a well block channel formed therein. A hollow cylindrical tap hole liner is placed in the well block channel, forming a tap hole passage in the side or bottom of the furnace. The tap hole passage defines the flow path of the molten metal out of the furnace.

The tap hole liner is typically formed of refractory material similar to the furnace lining and is held in position in the well block channel by bonding material, such as conventional gunite and “dry vibe” material or refractory material, which is poured or gunned into a gap formed between an exterior surface of the tap hole liner and the sides of the well block channel. The tap hole liner may also be supported by a retaining piece attached to the bottom of the furnace to prevent the tap hole liner from dropping out of the bottom of the well block channel during use.

Molten metal from the furnace flows through the tap hole passage formed by the tap hole liner and out of the side or bottom of the furnace. Typically, the tap hole liner will be eroded at a faster rate than the furnace liner. With time, the tap hole liner begins to burn away due to the passage of the molten metal, which increases the inside diameter of the tap hole passage. When the annular width of the tap hole passage increases to a certain predetermined point, the tap hole liner must be replaced. Typically, the tap hole liner is replaced on a regular basis during the life of the furnace liner.

Because converters are run at extreme elevated temperatures during use, and retain residual heat for a period of time even during tap hole liner replacement, there exists a danger to workers working near a BOF or other type of converter vessels. It is not economically feasible to allow the converter to cool completely for tap hole liner replacement. To help minimize the danger of personal injury, devices have been constructed to install or replace tap hole liners from outside the BOF/QBOP/AOD and all other types of converter vessels. One such device is a stationary, dedicated tap hole liner installation and replacement machine. The machine generally includes a stationary base, a water-cooled drill mounted on an indexable turret, and a tap hole liner insertion tool also mounted on the indexable turret. The dedicated machine must be moved into position by a crane or the like and also requires the attachment of a drill centering plate on the BOF/QBOP/AOD and all other types of converter vessels. Once moved into position the machine will index the drill into the operative position and removes a worn tap hole liner by drilling away the worn tap hole liner from an outside side or bottom portion of the BOF/QBOP/AOD and all other types of converter vessels. The drill is centered by coupling to the centering plate on the BOF. Following drilling, the drill is uncoupled from the drill centering plate and the turret is indexed to the insertion tool. A new tap hole line is placed on the insertion tool and the new tap hole liner is then inserted into the tap hole channel, again from the outside side or bottom portion of the BOF/QBOP/AOD and all other types of converter vessels. Refractory material or the like is gunned around the tap hole liner to complete the replacement process. The insertion tool is removed and the entire machine must be moved to a storage location by a crane or the like. The machine is relatively expensive and the operation labor intensive.

Although the generally stationary dedicated machine helps to alleviate many of the dangers inherent in installing and repairing tap hole liners, the dedicated machine has certain drawbacks. First, the machine can only be used for removing and installing tap hole liners, significantly reducing the cost versus utilization ratio of the machine. Second, the machine is non-mobile, so the machine must be lifted or otherwise transported by another mode of conveyance, such as a crane, thereby further increasing time and labor costs. Third, the machine does not have a self-centering drill for removing old tap hole liners. Instead, the drill centering or guide plate must be positioned adjacent to the tap hole channel before drilling can begin. Fourth, the machine is relatively complex and expensive, particularly due to the indexing turret arrangement. The indexing turret requires its own drive and requires a complex design for powering and supplying fluid (if needed) to the indexed tools. Further, the operation of the machine is relatively labor intensive. Additionally, the bulky machine must be stored during extended periods of non-use, thereby using valuable floor space.

It is therefore an object of the present invention to provide an improved method together with a versatile and mobile device for removing and installing tap hole liners in a BOF.

### SUMMARY OF THE INVENTION

The above objects are achieved with the method and apparatus according to the present invention. One embodiment of the present invention includes a multi-purpose utility vehicle and a water-cooled self-centering drill attachment removably attached to the multi-purpose utility vehicle. In one embodiment, a tap hole liner installation guide is positioned adjacent to the multi-purpose utility vehicle in place of the water-cooled self-centering drill attachment. The water- cooled self-centering drill and the installation guide are used, respectfully, to remove and install tap hole liners in a BOF/QBOP/AOD and all other types of converter vessels.

A general method of operation according to the present invention includes the steps of:

(a) moving a multi-purpose utility vehicle adjacent to the BOF/QBOP/AOD and all other types of converter vessels in a drilling position;

(b) connecting a water-cooled self-centering drill to the multi-purpose utility vehicle;

(c) drilling a spent tap hole liner from a tap hole channel formed in the BOF/QBOP/AOD and all other types of converter vessels using the self-centering drill;

(d) removing the water-cooled self-centering drill from the multi-purpose utility vehicle;

(e) removably attaching a tap hole liner installation guide to the multi-purpose utility vehicle;

(h) positioning a new tap hole liner on the tap hole liner installation guide;

(i) inserting the tap hole liner installation guide into the tap hole channel formed in the BOF/QBOP/AOD and all other types of converter vessels;

(j) placing gunite or other suitable refractory material around an outer surface of the tap hole liner; and

(k) slidably removing the tap hole liner installation guide from the internal surface of the tap hole liner.

These and other advantages of the present invention will be clarified in the brief description of the preferred embodiments taken together with the attached figures.

A complete understanding of the invention will be obtained from the following description when taken in connection with the accompanying drawings wherein like reference numerals represent like elements throughout.

### BRIEF DESCRIPTION OF THE DRAWINGS

FIG. 1 is a side view, partially in section, of an apparatus for replacing tap hole liners in a BOF/QBOP/AOD and all other types of converter vessels according to a first embodiment of the present invention, including a water-cooled self-centering drill and a multi-purpose utility vehicle, with the water-cooled self-centering drill inserted into a tap hole formed in the BOF/QBOP/AOD and all other types of converter vessels;

FIG. 2 is an enlarged side view, partially in section, of the water-cooled self-centering drill and the tap hole shown in FIG. 1;

FIG. 3 is a side view of the water-cooled self-centering drill shown in FIGS. 1 and 2;

FIG. 4 is a side view of the water-cooled self-centering drill shown in FIGS. 1-3 and a tap hole liner installation guide for the apparatus for replacing tap hole liners in a BOF/QBOP/AOD and all other types of converter vessels according to the present invention; and

FIG. 5 is flow chart of the method of replacing tap hole liners in a BOF/QBOP/AOD and all other types of converter vessels according to the present invention.

### DETAILED DESCRIPTION OF THE PREFERRED EMBODIMENTS

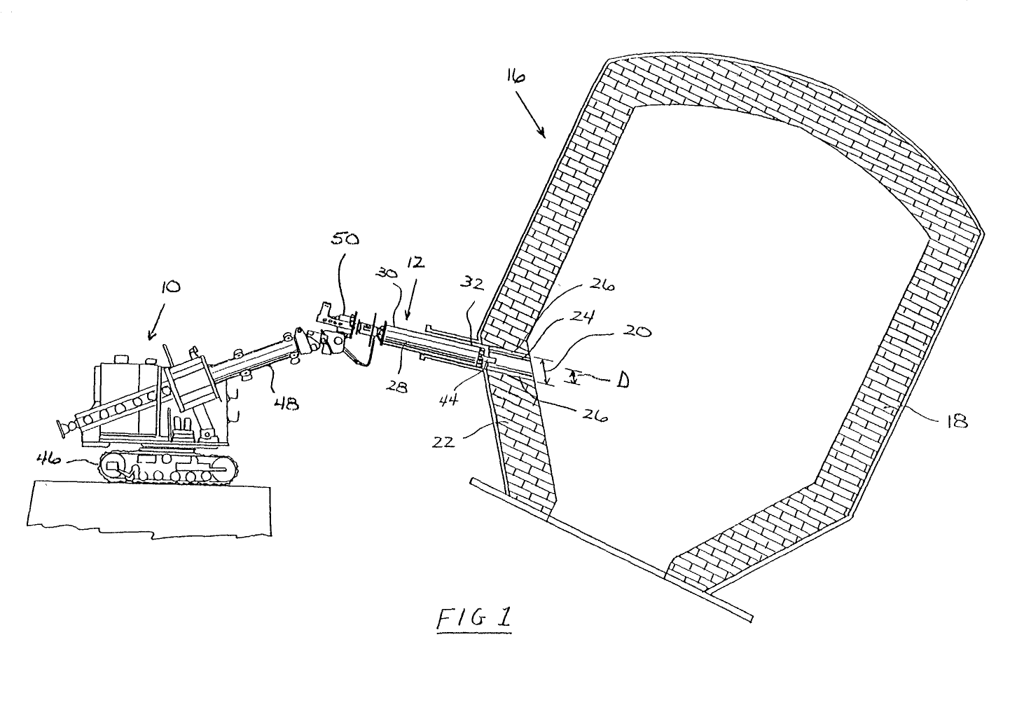

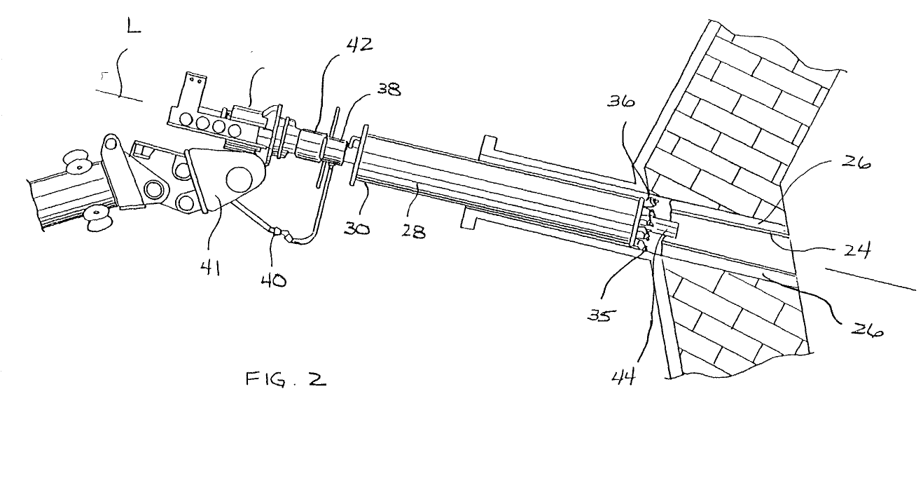

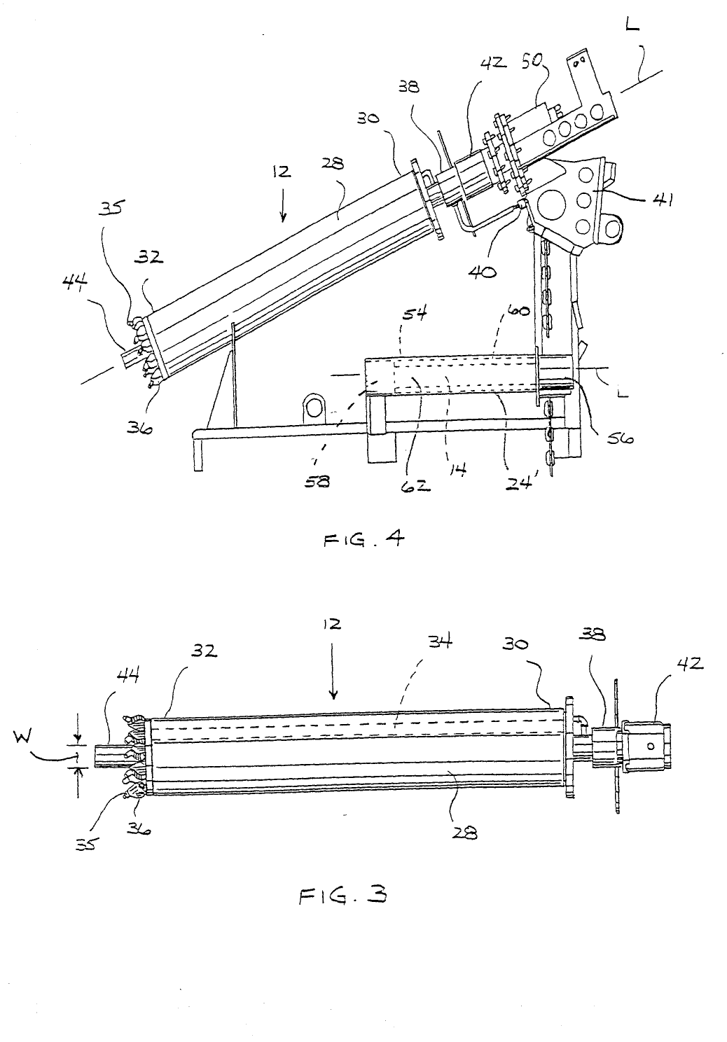

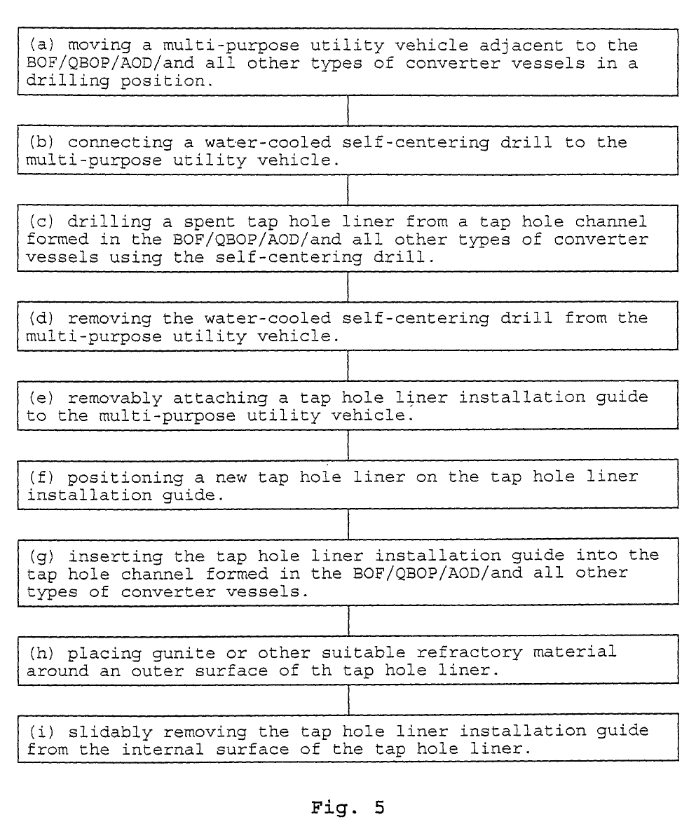

As shown in FIGS. 1-4, and particularly FIGS. 1 and 2, one embodiment of the apparatus for replacing tap hole liners in a BOF/QBOP/AOD and all other types of converter vessels according to the present invention generally includes a multi-purpose utility vehicle 10 and a water-cooled self-centering drill 12 removably attached to the multi-purpose utility vehicle 10. Additionally, shown in FIG. 3, the apparatus for replacing tap hole liners includes a tap hole liner installation guide 14 that is removably attached to the multi-purpose utility vehicle 10, shown in FIGS. 1 and 2, in place of the water-cooled self-centering drill 12.

FIG. 1 schematically shows a BOF/QBOP/AOD and all other types of converter vessels 16, a water-cooled self-centering drill 12 and a multi-purpose utility vehicle 10. The BOF/QBOP/AOD and all other types of converter vessels 16 generally includes a BOF/QBOP/AOD and all other types of converter vessels body 18 forming a tap hole channel 20 in a bottom side or bottom BOF/QBOP/AOD and all other types of converter vessels body portion 22. A tap hole liner 24 is positioned inside the tap hole channel 20 and is sealed with a refractory material 26.

The water-cooled self-centering drill 12 includes a core drill body 28 extending along a longitudinal axis L. The core drill body 28 has a first end 30, a second end 32, and a water jacket 34 connecting the first end 30 with the second end 32. The water jacket 34 is formed essentially by concentric tubes extending from the first end 30 to the second end 32 to form a fluid passageway from the first end 30 to the second end 32. The concentric tubes can be connected by the first end 30 and the second end 32 as well as intermediate supports as needed for structural considerations. The first end 30 and the second end 32 essentially cap the water jacket 34. The second end 32 includes a plurality of nozzles 35 aligned with individual cutting teeth 36 whereby water jacket 34 is fluidly connected to the plurality of cutting teeth 36 positioned adjacent the second end 32 of the core drill body 28. The water jacket 34 may be formed in ways other than an annular jacket extending the length of the core drill body 28. For example, a single fluid pipe could lead to an annular chamber adjacent the second end 32. However, the annular water jacket 34 of the present design serves to cool the core drill body 28 as well as the cutting teeth 36.

The water-cooled self-centering drill 12 further includes a water annulus 38 positioned adjacent to the first end 30 of the core drill body 28. A water coupler 40 is positioned on a base 41 with a fluid line extending from the base 41 to the water annulus 38. A drive and disconnect assembly 42, preferably a square drive head with a locking cross pin connect, is positioned adjacent the water annulus 38. The drive and disconnect assembly 42 provides for quick attachment to the rotation power source for the drill 12, as will be described hereinafter.

The cutting teeth 36 are arranged in a desired lacing pattern for efficiently cutting out a worn tap hole liner 24, preferably two adjacent teeth 36 facing generally radially outwardly, and the next one adjacent cutting tooth 36 facing generally radially inwardly, with respect to the longitudinal axis L of the core drill body 28. A centering mandrel 44 is also positioned adjacent to the second end 32 of the core drill body 28, with the centering mandrel 44 having a width W that generally corresponds to an inner diameter D of the tap hole liner 24. The centering mandrel 44 extends forwardly of the cutting teeth 36 to align the cutting teeth 36 of the water-cooled self-centering drill 12 during the tap hole liner 24 removal process.

The multi-purpose utility vehicle 10 is self-driven, such as a GRANT-O-MATIC Model 360 BDR or 360 BDRE brand of multi-purpose utility vehicle 10 manufactured by Louis A. Grant, Inc. of Export, Pa. In general, the GRANT-O-MATIC brand of multi-purpose utility vehicle 10 includes a tracked carriage 46 having an extendable arm 48. The extendable arm 48, shown in FIGS. 1-4, includes a drive assembly 50 having a drive shaft 52. The extendable arm 48 removably connects to the base 41 of the water-cooled self-centering drill 12 so that the entire drill 12 can be mounted or removed as a single attachment. The vehicle 10 provides for moving the drill 12 and guide 14.

The drill 12 includes a drive assembly 50 mounted on the base 41 and having a drive shaft connected to the drive and disconnect assembly 42 for rotation of the drill 12. Consequently, the drill 12 includes its own rotation source. It is anticipated that the base 41 and drive assembly 50 could be eliminated with the drive and disconnect assembly 42 of the drill 12 attached directly to the drive shaft of the extendable arm 48 so that the vehicle 10 also would provide for the rotation of the drill 12.

The tap hole liner installation guide 14 (FIG. 2) is also removably connected to the extendable arm 48 of the multi-purpose utility vehicle 10. The tap hole liner installation guide 14 extends about a longitudinal axis L′ and has an insert end 54 and a connection end 56. A spacer 58 is positioned adjacent to the insert end 54 of the tap hole liner guide 14, the spacer 58 having an external diameter D′ which is approximately equal to an internal diameter D of a new hollow tap hole liner 24′, the tap hole liner 24′ further forming an internal surface 60 and an external surface 62. The tap hole liner 24′ is slid over the tap hole liner guide 14 prior to installation of the tap hole liner 24′ in the tap hole channel 20 formed by the BOF/QBOP/AOD and all other types of converter vessels body 18. The connection end 56 of the tap hole liner installation guide 14 is removably connected to the extendable arm 48. Other attachments, such as a gunite sprayer (not shown), can also be removably connected to the drive assembly of the extendable arm 48 in place of the water-cooled self-centering drill 12 or the tap hole liner guide 14.

One method of operation, specifically the removal of a spent tap hole liner 24, begins by preparing the BOF/QBOP/AOD and all other types of converter vessels 16 for tap hole liner 24 replacement. The preparation of the BOF/QBOP/AOD and all other types of converter vessels 16 according to the method of the present invention does not require modifying the BOF/QBOP/AOD and all other types of converter vessels 16 to include drill centering structures or the like. Essentially, there is no substantial or significant preparation required for the BOF/QBOP/AOD and all other types of converter vessels 16 in the method of the present invention as compared to prior art methods. Another step is moving the multi-purpose utility vehicle 10 adjacent to the BOF 16 in a drilling position. A further step is connecting the drill 12 to the utility vehicle 10 including attaching a water supply to the water annulus 38. Power and control connections for the drive assembly 50 are also made. The water supply should flow at 7 gmp at 30 psi. With the vehicle 10 positioned and the drill 12, power, controls and water supply connected, the next step is drilling the spent tap hole liner 24 from the tap hole channel 20. It has been found that the drilling process takes approximately 1 minute with the apparatus according to the present invention. When the spent tap hole liner 24 has been drilled out of the tap hole channel 20, the next step is removing the water-cooled self-centering drill 12 from the drive assembly 50 and removably attaching the tap hole liner guide 14 to the drive assembly 50 of the extendable arm 48. Positioning a new tap hole liner 24′ on the tap hole liner guide 14 can take place either before or after the step removably attaching the tap hole liner guide 14 to the drive assembly 50. The next step is inserting the tap hole liner guide 14 into the tap hole channel 20 formed by the BOF/QBOP/AOD and all other types of converter vessels body 18. With the new tap hole liner 24′ in position, the next step is spraying gunite or other suitable refractory material 26 around the external surface 62 of the tap hole liner 24′, sealing the tap hole liner 24′ in the tap hole channel 20. The last step is slidably removing the tap hole liner guide 14 from the internal surface 60 of the tap hole liner 24′. This last step takes approximately 4 to 5 minutes, on average.

As illustrated by the above Detailed Description, the embodiment of the present invention provides an improved method together with a versatile and mobile device for removing and installing tap hole liners in a BOF/QBOP/AOD and all other types of converter vessels. The water cooled self-centering drill 12 is specifically designed to easily remove spent tap hole liners 24. The centering mandrel 44 is sized for specific tap hole liners 24, further centering mandrels or annular additions to the mandrel 44 may be provided for differently sized tap hole liners 24. The water cooled jacket 34 and nozzles 35 are designed to cool the drill 12 and the cutting teeth 36 to increase the working life of the cutting teeth 36 and the drill 12. Although the nozzle 35 is generally associated with each cutting tooth 36, in operation it is expected that the cooling fluid (generally water) will turn to steam prior to reaching the cutting teeth 36 due to the elevated operating conditions of the BOF/QBOP/AOD and all other types of converter vessels (even during tap hole repair operations). The lacing pattern of the cutting teeth 36 is specifically designed for drilling tap hole liners 24, in other words, the lacing pattern is designed for drilling an annular refractory workpiece as opposed to merely drilling a borehole or the like. The cutting teeth 36 may be rock bits or other cutting tips suitable for refractory workpieces. The drill 12 and guide 14 represent significantly less capital investment than an entire dedicated machine (even including the cost of the vehicle 10). The present design does not require a complex turret or drive system. Further, the vehicle 10 is useful in other areas of the mill between tap hole replacement times. With the vehicle 10 likely to be in operation elsewhere between tap hole replacements, the only elements to be stored are the drill 12 and the guide 14. The simple design and operation reduces the labor costs associated with the operation of the present invention.

It will be apparent to those of ordinary skill in the art that various modifications may be made to the present invention without departing from the spirit and scope thereof. The scope of the present invention is defined by the appended claims and equivalents thereto.

We claim:

1. An apparatus for replacing the tap hole liner of a Basic Oxygen Furnace, the apparatus comprising:
a multi-purpose movable utility vehicle; and
a water-cooled self-centering drill removably attached to the multi-purpose utility vehicle.

2. The apparatus of claim 1 further including a tap hole liner installation guide removably attached to the multi-purpose movable utility vehicle in place of the water-cooled self-centering drill attachment.

3. The apparatus of claim 1 wherein the self-centering drill includes a centering mandrel extending in advance of cutting teeth of the drill, the centering mandrel having a diameter substantially equal to an interior diameter of the tap hole liner.

4. The apparatus of claim 1 wherein the drill includes a base and a drive apparatus mounted on the base, wherein the base is removably attached to the vehicle.

5. The apparatus of claim 1 wherein the drill includes a plurality of cutting teeth and wherein two adjacent cutting teeth extend generally radially outwardly and a next adjacent cutting tooth extends generally radially inwardly.

6. The apparatus of claim 1 wherein the water-cooled drill includes an annular water jacket extending along the length of the drill.

7. A method of replacing the tap hole liner of a Basic Oxygen Furnace, the method comprising the steps of:
(a) moving a multi-purpose utility vehicle adjacent to the BOF/QBOP/AOD and all other types of converter vessels in a drilling position;
(b) connecting a water-cooled self-centering drill to the multi-purpose movable utility vehicle;
(c) drilling a spent tap hole liner from a tap hole channel formed in the BOF/QBOP/AOD and all other types of converter vessels using the self centering drill;
(d) removing the water-cooled self-centering drill from the multi-purpose movable utility vehicle;
(e) removably attaching a tap hole liner installation guide to the multi-purpose movable utility vehicle;
(h) positioning a new tap hole liner on the tap hole liner installation guide;
(i) inserting the tap hole liner installation guide into the tap hole channel formed in the BOF/QBOP/AOD and all other types of converter vessels;
(j) placing suitable refractory material around an outer surface of the tap hole liner; and
(k) slidably removing the tap hole liner installation guide from the internal surface of the tap hole liner.

8. The method of claim 7 wherein the water-cooled drill includes an annular water jacket extending along the length of the drill.

9. The method of claim 7 wherein the self-centering drill includes a centering mandrel extending in advance of cutting teeth of the drill, the centering mandrel having a diameter substantially equal to an interior diameter of the tap hole liner.

10. The method of claim 7 wherein the drill includes a base and a drive apparatus mounted on the base, wherein the base is removably attached to the vehicle.

11. The method of claim 7 wherein the drill includes a plurality of cutting teeth and wherein two adjacent cutting teeth extend generally radially outwardly and a next adjacent cutting tooth extends generally radially inwardly.
